(19) United States
(12) Patent Application Publication
(10) Pub. No.: US 2005/0251689 A1
(43) Pub. Date: Nov. 10, 2005

(54) Computer system for playing encrypted multimedia data and method for the same

(76) Inventors: Wen-Chieh Lee, Taipei (TW); Chi-Min Liu, Taipei (TW); Tsun-Chung Yang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/068,746

(22) Filed: Mar. 2, 2005

(30) Foreign Application Priority Data
May 4, 2004 (TW) 093112528

(51) Int. Cl. H04L 9/32; G06F 11/30; G06F 12/14

(52) U.S. Cl. 713/189; 713/193

(57) ABSTRACT

A computer system and a method for playing encrypted multimedia data are proposed. The computer system has a first operating system that heavily consumes system resources and a second operating system that slightly consumes the system resources. Via a basic input/output system (BIOS), the computer system is booted with a second operating system. The second operating system uses a multimedia-receiving unit to receive remote encrypted multimedia data and store the data into a storage unit. The second operating system uses a decrypting unit to access at least one kind of the encrypted multimedia data stored in the storage unit and the register information corresponding to the encrypted multimedia data from a first operating system for decryption. After the decrypting operation is completed, a playback unit is used to access the multimedia data that has been decrypted for perform a playback operation.

### BACKGROUND OF THE INVENTION

1. Field of the Invention

The present invention is related to a computer system and a method for playing encrypted multimedia data. Via a basic input/output system (BIOS), the computer system is booted with a second operating system (OS), which occupies less system resources. The second operating system uses a decrypting unit to access at least one kind of encrypted multimedia data stored in a storage unit and register information corresponding to the encrypted multimedia data from a first operating system for decryption. After the decryption is completed, a playback unit is used to access the multimedia data that has been decrypted for perform a playback operation.

2. Description of Related Art

In the early days, the information technology is laggard. Time and regions restrict the leisure activities. For example, people need to go to libraries or bookstores to read new books or watch a TV program at a specific time. In recent years, since the information and network technologies are progressing, the computer systems have various functions nowadays. Via access of digital contents, people can download new electronic book, videos and multimedia data. Hence, the digital services have come into people's daily life deeper and deeper.

The so-called digital content refers to the digitalized images, text, pictures, audio and so on. The digital services are to provide these digitalized data. The contents of education, entertainments, cultures and arts are traditional but have commercial value. By using the information technology nowadays, these contents can be transformed into digital contents so as to make these contents easy to be duplicated and have more added values. Moreover, after digitalization, these traditional contents can be used to provide products that have interactive functions and integrate video, audio and image data. Via the present information technology, various digital contents are transmitted to clients via traditional or new-developed networks or media to provide various services.

In the digital services, digital audio services are most close to people's life and accepted extensively by people. The reason is that audio files need less memory and can be stored in a small storage device. Via the storage device, people can easily enjoy music anywhere. It is very convenient and has portability. Therefore, the development of digital audio always gets a lot of attention.

In the digital world of computers, audio is stored via digital data. In general, audio can be classified into two types, namely sound waves and compound sound effects. Therein, the data of the compound sound effects fit in with the standard of music instrument digital interface (MIDI). The sound waves are digitalized via analog-to-digital converters (ADC) and stored in computer storage media. The compound sound effects are formed by combining some sound sources built in computer systems.

A common data format of sound waves is “Wave”. The data fitting in with this format are stored as “*.wave” files. However, for producing sound wave for one minute, it needs 10 MB data that fit in with the Wave format. That needs to occupy much memory. Hence, the MP3 format was developed to solve this problem.

In 1999, the MP3 technology was chosen as one of the top ten best network technologies in Time magazine of U.S.A. The MP3 technology has caused important revolution in music world and provided quit a few chances of business. All the music providers are interested in development of applications of MP3 digital contents. Hence, MP3 players and MP3 digital services provided via Internet are introduced in the market. It makes MP3 applications accepted extensively by people.

MP3 sound data are one kind of sound wave data. The original sound wave data can be compressed to fit in with the MP3 format. Via compression, 50˜60 MB Wave data can be converted into about 4 MB MP3 data and the sound quality provided by MP3 data is almost the same as that provided by common music CDs. Thus, the size of MP3 data is ten times smaller than that of Wave data. Hence, one MP3 optical disc can accommodate more than ten-fold music contents of the music CD. If one music CD can provide music for 60 minutes, one MP3 optical disc can provide music more than ten hours. It is like a small music cabinet. That is why the MP3 related applications are so popular.

The full name of MP3 is Movie Picture Experts Group (MPEG) Layer 3, which belongs to MPEG-1 layer. The MP3 standard was developed to lower the loading for information transmission and keep the sound quality. Since MP3 data occupy less memory and the bandwidth of Internet is limited, many music providers provide MP3 digital services via Internet for competition. Thus, users can pay monthly for obtaining the download right of MP3 music files. However, since Internet can be found everywhere and MP3 music files provide good quality of music and are easily downloaded and reproduced, sometimes users can obtain the right that they should not have. It challenges the sale mechanisms of music providers. If this problem can be overcome, reliable high-quality digital contents with high efficiency and high interactivity could be provided.

In order to solve the problem that MP3 files can be reproduced and transmitted easily, network security and digital content protection got a lot of attention recently. Reference is made to FIG. 1, which is a block diagram for illustrating a method of data protection. Via a symmetric or asymmetric security mechanism, digital data can be protected during transmission. As shown in the figure, an encrypting unit 15′ is used to receive the incoming data 10′ that are ready for encryption and an encrypting key 20′. After the incoming data 10′ are encrypted, they can be provided via Internet. Only the user that has the decrypting key 30′ corresponding to the encrypting key 20′ can decrypt the encrypted data by using the decrypting key 30′ and the decrypting unit 25′ to produce decrypted data 35′. Therein, the incoming data 10′ are the same as the decrypted data.

In order to extend the business in MP3 Internet transaction, Apple Computer Company introduced iTune serial products that have a capability for protection of digital data. One can first download encrypted MP3 files and a MP3 player that is capable of decrypting the MP3 files. He can use the decrypting key and the MP3 player obtained from the Music provider to decrypt the encrypted MP3 files and play the MP3 files. Therein, the decrypting key is formed by combining a partial system key and a partial client key. The partial system key is provided by the music provider directly. The partial client key is produced by the music provider according to user's hardware information, such as an IP address, a network card's number and so on, accessed during the registration operation is performed. Thus, no one can play the MP3 files expect the user having the decrypting key. Hence, MP3 files can be protected from arbitrary reproduction and transmission.

Although the iTune serial products provided by Apple Company can protect MP3 contents, one has to download or purchase a corresponding player and these products are only suitable for operation in Macintosh computers and Window operating systems. However, Macintosh computers and Window operating systems occupy system resources heavily. Hence, when one wants to play music via his computer, he needs to wait quit a while for computer booting. Furthermore, in order to save the resources via prevention of reinstallation, how to let the Linux operating system and Windows operating system installed in a computer system to share the resources of each other is an important point that needs to be considered.

In recent years, since the information technology is progressing unceasingly, except development of the encrypted MP3 information, it is believed that the encrypted multimedia data, such as encrypted video data, encrypted text data and so on, will be developed. Hence, how to provide a multimedia player with a decrypting capability and make the low-loading operating system and the high-loading operating system share the resources of each other for prevention of reinstallation of application programs to save the memory and reduce the booting time is an important issue that needs to be emphasized and considered.

Therefore, how to provide a computer system and a method for playing encrypted multimedia data to resolve the drawbacks of the prior art so as to solve the problem that the conventional multimedia player can not play the encrypted multimedia data and make two operating systems able to share the multimedia player capable of decrypting the encrypted data and the register information corresponding to the encrypted data has been desired for a long time. Accordingly, in view of the research, development and practical sale experiences of the related products for many years, the inventor of the present invention sought to improve the prior art. Via inventor's professional knowledge and his research, design and case study in many ways, the inventor finally proposes a computer system and a method for playing encrypted multimedia data to resolve the drawback mentioned above.

### SUMMARY OF THE INVENTION

An objective of the present invention is to provide a computer system and a method for playing encrypted multimedia data. The computer system has a first operating system that heavily consumes system resources and a second operating system that slightly consumes the system resources. The computer system runs the second operating system for encrypting the encrypted multimedia data. The second operating system uses a decrypting unit to access at least one kind of encrypted multimedia data stored in a storage unit and the register information corresponding to the encrypted multimedia data of the first operating system to perform a decrypting operation. When the decrypting operation is completed, the second operating system uses a playback unit to access the multimedia data that have been decrypted to perform a playback operation.

Another objective of the present invention is to provide a computer system and a method for playing encrypted multimedia data to fulfill user's requirements in a fast manner. Using the present invention makes one able to directly use the second operating system that consumes less system resources to control the decrypting unit, the playback unit and the register information, which provides the decrypting information, of the first operating system that consumes more the system resources. It means that using the present invention can reduce the time for activating the operating system to play decrypted multimedia data. Thus, the present invention can fulfill the user's requirements in a fast manner.

Another objective of the present invention is to provide a method for storing remote encrypted multimedia data. After the computer system is booted with the second operating system, an input unit can be used to input an external command. After the external command is received by a central processing unit (CPU), the central processing unit drives a multimedia-receiving unit to receive at least one kind of remote multimedia data and store t into the storage unit. Then, the decrypting unit accesses register information corresponding to the remote multimedia data to perform a decrypting operation. After the decrypting operation, the multimedia data is delivered to the playback unit to perform a playback operation.

Another objective of the present invention is to save the memory. The second operating system is able to share the decrypting unit and the playback unit of the first operating system so that the memory is saved efficiently.

Still another objective of the present invention is to provide a power-saving function. After the second operating system, which occupies less system resources, is activated, only the system resources needed for the decrypting unit and the playback unit are used. Thus, the present invention reduces the power consumption of the system.

For achieving the objectives above, the present invention provides a computer system and a method for playing encrypted multimedia data. The computer system has a first operating system and a second operating system installed therein. The first operating system occupies more system resources than the second operating system when in use. A basic input/output system (BIOS) of the computer system is used to activate the second operating system for booting. An input unit can be used to send a command for decrypting at least one kind of encrypted multimedia data. After a central processing unit (CPU) receives the command, the second operation system invokes a decrypting unit and a playback unit of the first operating system and accesses register information of the first operating system. The decrypting unit accesses at least one kind of encrypted multimedia data corresponding to the register information from a storage unit and decrypts the multimedia data via the register information. After the decrypting operation is completed, the playback unit accesses the multimedia data that has been decrypted and performs a playback operation. Therein, the present invention further includes a multimedia-receiving unit for receiving at least one kind of remote multimedia data and storing it into the storage unit for decryption. Since the present invention can uses the system resources of the first operating system without activation of the first operating system, the activating time of the first operating system that occupies more system resources and memory is reduced. Thus, the present invention reduces the power consumption and saves the memory efficiently.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram for illustrating a method of data protection;

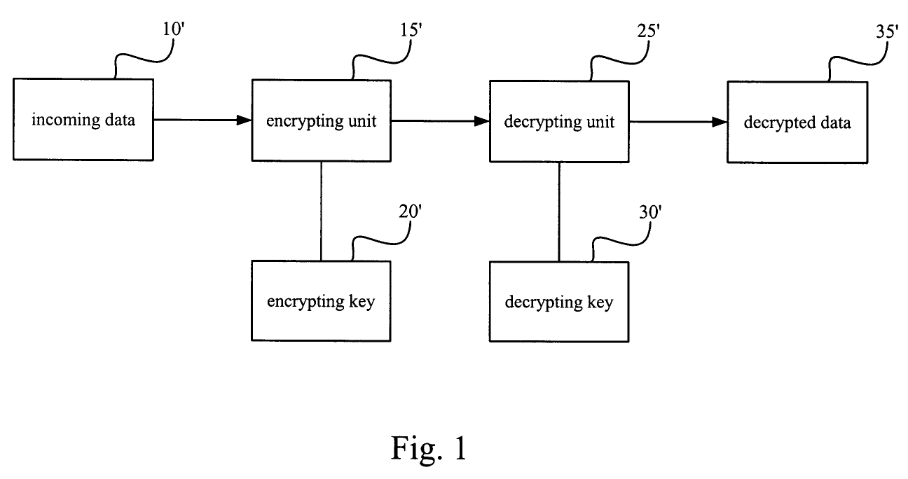

FIG. 2 is a block diagram for illustrating the data-sharing concept in accordance with the first preferred embodiment of the present invention;

FIG. 3 is a block diagram of the first preferred embodiment in accordance with the present invention;

FIG. 4 is a block diagram of another preferred embodiment in accordance with the present invention;

FIG. 5 is a block diagram of a preferred embodiment that is capable of receiving remote multimedia data in accordance with the present invention; and

FIG. 6 is flow chart of a preferred embodiment in accordance with the present invention.

### DETAILED DESCRIPTION OF PREFERRED EMBODIMENTS

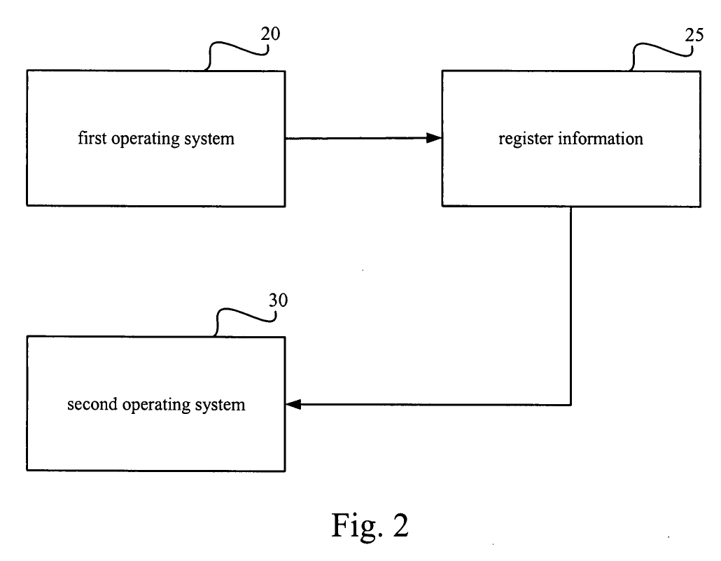

Reference is made to FIG. 2, which is a block diagram for illustrating the data-sharing concept in accordance with the first preferred embodiment of the present invention. As shown in the figure, the present invention is applied for a computer system having a first operating system 20 (OS) that consumes system resources heavily and a second operating system 30 that consumes the system resources slightly. Via the basic input/output system (BIOS), the second operating system 30 is activated for booting the computer system. The second operating system shares register information 25 of the first operating system 20. The register information 25 provides the decrypting information corresponding to at least one kind of encrypted multimedia data. It means that the register information 25 provides the decrypting key needed for decrypting the encrypted multimedia data.

Therein, the register information 25 can be a register code corresponding to an application program. If one is a legal user, he can use the application program in the second operating system 30. When the application program is activated, the second operating system 30 automatically accesses the register code from the first operating system 20 to make the application program executable.

Furthermore, the register information 25 can also be cookie information, which has recognition information transmitted from a remote website server to the computer system. When one uses the second operating system 30 to surf web pages, the second operating system 30 automatically accesses the cookie information from the first operating system 20. Thus, one can use the information of the web pages that have been viewed when the first operating system is used.

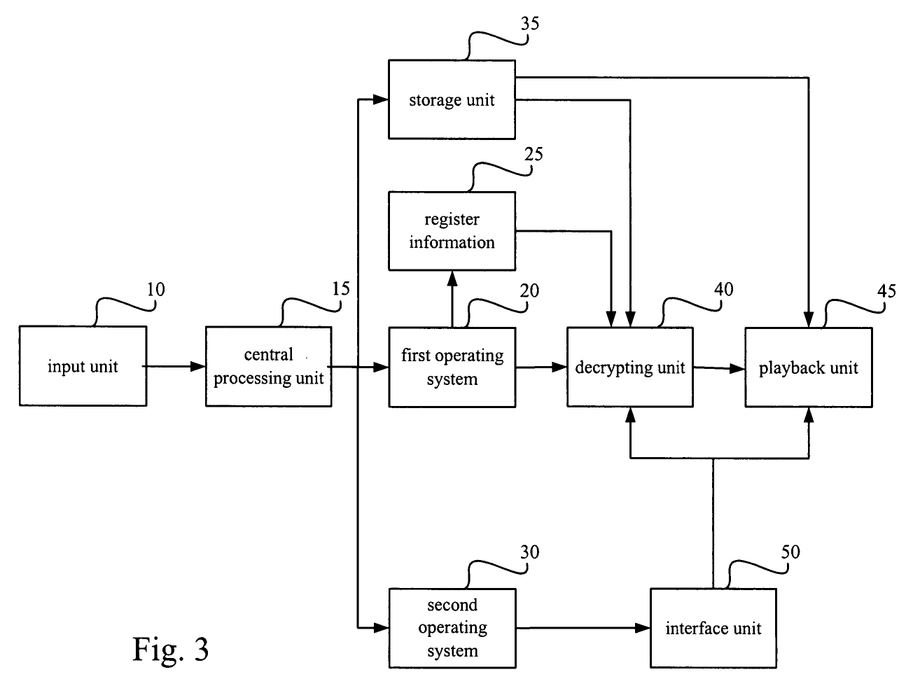

Reference is made to FIG. 3, which is a block diagram of the first preferred embodiment in accordance with the present invention. In this embodiment, the second operating system 30 is activated via the basic input/output system to boot the computer system, and the decryption operation of the encrypted multimedia data is performed in the second operating system 30. An input unit 10 is used to issue a decrypting command to invoke a decrypting operation of at least one kind of the encrypted multimedia data. The input unit 10 can be a keyboard or a wireless remote controller. After a central processing unit (CPU) 15 of the computer system receives the decrypting command, the central processing unit 15 sends a command to make an interface unit 50 convert the format of relative parameters of a decrypting unit 40 and a playback unit 45 of the first operating system 20 into an executable format for the second operating system 30.

In this way, the second operating system 30 shares the decrypting unit 40 and the playback unit 40 of the first operating system 20. Thereby, the time consumed for booting the first operating system 20, which heavily consumes the system resources and occupies a memory larger than the second operating system 30, is reduced. Besides, the application programs do not need to install in both of the first operating system 20 and the second operating system 30. Thus, the present invention saves the memory effectively.

The second operating system 30 uses the decrypting unit 40 to access at least one kind of encrypted multimedia data stored in a storage unit 35 and the register information 25 corresponding to the encrypted multimedia data of the first operating system 20 to perform a decrypting operation. When the decrypting operation is completed, the second operating system 30 uses the playback unit 45 to access the multimedia data that have been decrypted to perform a playback operation.

The foresaid storage unit 35 can be a common hard disk (HD) or a hard disk equipped with a universal serial bus (USB) interface. The storage unit 35 s used to provide at least one kind of multimedia data. If the storage unit 35 has multimedia data that is not encrypted, the playback unit 45 can access the multimedia data and play it directly. Furthermore, the register information 25 provides the decrypting information corresponding to the encrypted multimedia data. It means that the register information 25 provides the decrypting key needed in the decrypting operation. When one purchases and downloads the encrypted multimedia data, he obtains the register information 25 from the vender. The decrypting unit 40 has several decrypting modules initially. One can download new decrypting modules periodically to update the decrypting unit 40. Thus, the aim to play encrypted multimedia data is achieved.

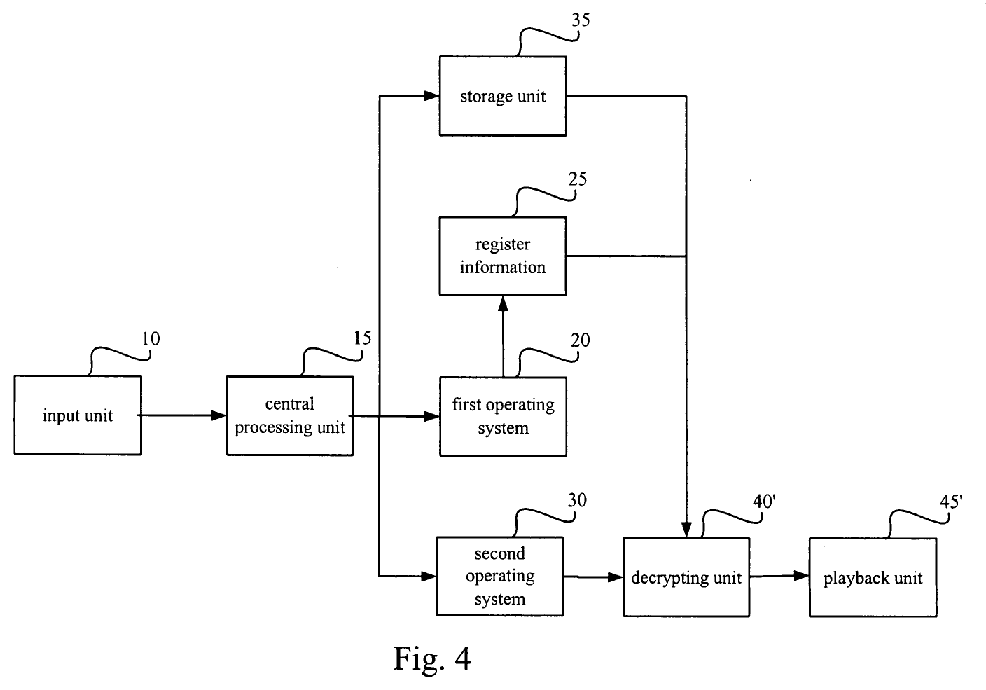

Reference is made to FIG. 4, which is a block diagram of another preferred embodiment in accordance with the present invention. As shown in the figure, the decrypting unit 40′ and the playback unit 45′ are installed in the second operating system 30. The second operating system 30 uses the decrypting unit 40′ to access at least one kind of encrypted multimedia data stored in a storage unit 35 and the register information 25 corresponding to the encrypted multimedia data of the first operating system 20 to perform a decrypting operation. When the decrypting operation is completed, the second operating system 30 uses the playback unit 45′ to access the multimedia data that have been decrypted to perform a playback operation.

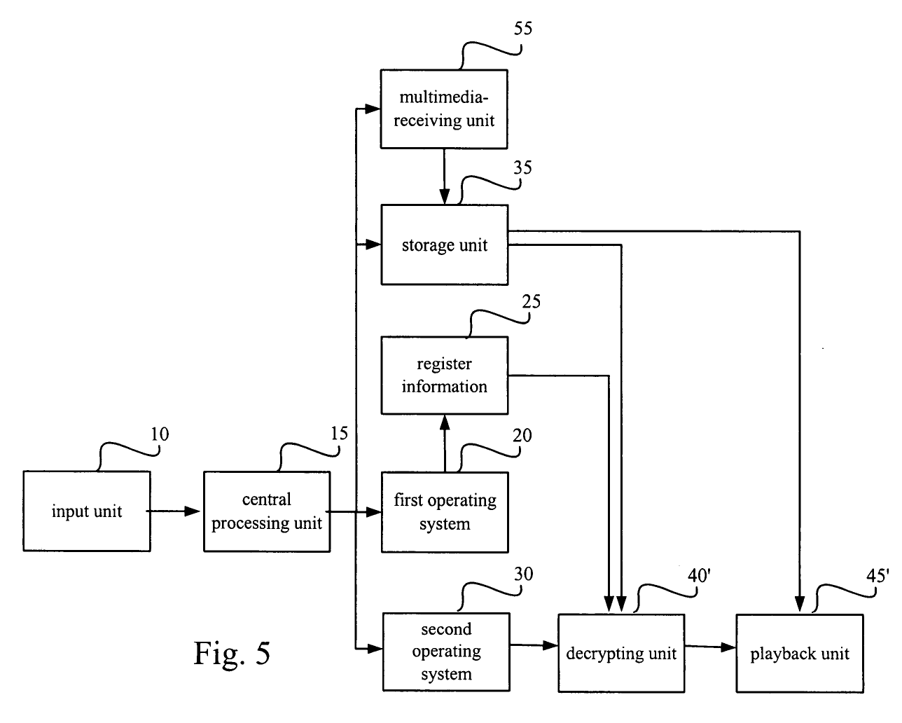

Reference is made to FIG. 5, which is a block diagram of a preferred embodiment that is capable of receiving remote multimedia data in accordance with the present invention. As shown in the figure, the computer system includes a multimedia-receiving unit 55. When one wants to receive at least one kind of remote multimedia data, he can input an external command to the central processing unit 15 to drive the multimedia-receiving unit 55 to receive the remote multimedia data and store it in the storage unit 35. If the remote multimedia data received is encrypted, the decrypting unit 40 is used to access this encrypted multimedia data together with its register information 25 to perform the decrypting operation. After the decrypting operation is completed, the multimedia data is passed to the playback unit 45 to perform the playback operation. Therein, if the remote multimedia data is transmitted via analog signals, the multimedia-receiving unit can further be equipped with a converter to convert the analog signals into digital multimedia data.

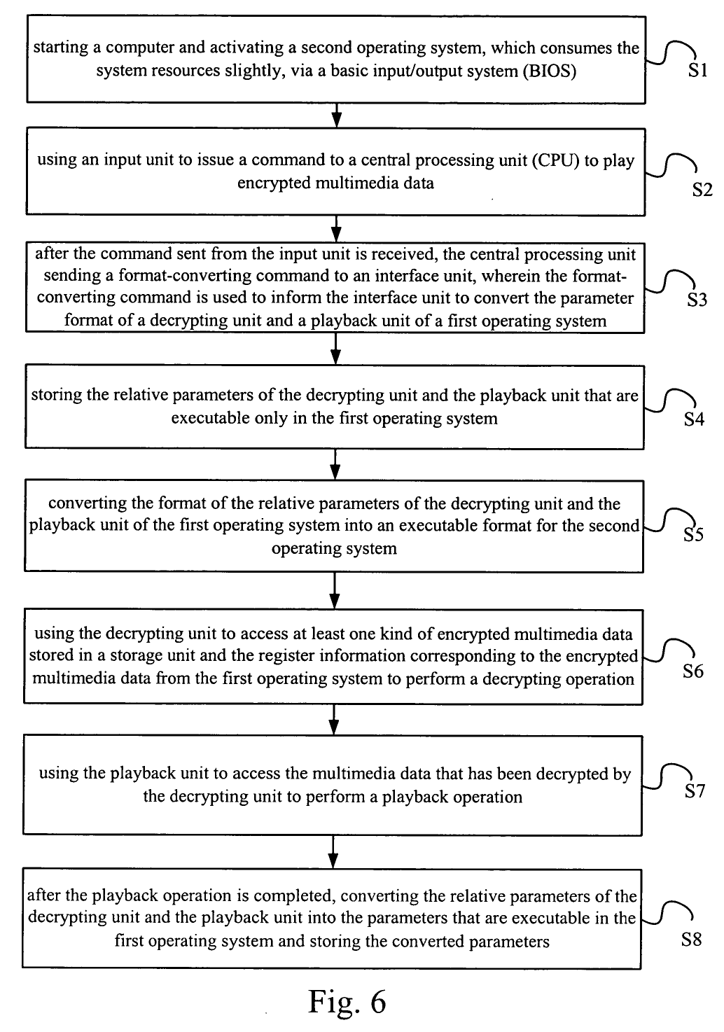

Reference is made to FIG. 6, which is flow chart of a preferred embodiment in accordance with the present invention. The method of the present invention has the steps as follows:
Step S1: starting a computer and activating a second operating system, which consumes the system resources slightly, via a basic input/output system (BIOS);
Step S2: using an input unit to issue a command to a central processing unit (CPU) to play encrypted multimedia data;
Step S3: after the command sent from the input unit is received, the central processing unit sending a format-converting command to an interface unit, wherein the format-converting command is used to inform the interface unit to convert the parameter format of a decrypting unit and a playback unit of a first operating system;
Step S4: storing the relative parameters of the decrypting unit and the playback unit that are executable only in the first operating system;
Step S5: converting the format of the relative parameters of the decrypting unit and the playback unit of the first operating system into an executable format for the second operating system;
Step S6: using the decrypting unit to access at least one kind of encrypted multimedia data stored in a storage unit and the register information corresponding to the encrypted multimedia data from the first operating system to perform a decrypting operation;
Step S7: using the playback unit to access the multimedia data that has been decrypted by the decrypting unit to perform a playback operation; and
Step S8: after the playback operation is completed, converting the relative parameters of the decrypting unit and the playback unit into the parameters that are executable in the first operating system and storing the converted parameters.

As the description above, the present invention is related a computer system and a method for playing encrypted multimedia data. The computer system has a first operating system that heavily consumes system resources and a second operating system that slightly consumes the system resources. First, a user may activate the second operating system via a basic input/output system (BIOS) to boot the computer system. Then, he can use an input unit to input a command to a central processing unit (CPU) to decrypt at least one kind of encrypted multimedia data. After the command sent from the input unit is received, the central processing unit sends a format-converting command to an interface unit. Therein, the format-converting command is used to inform the interface unit to convert the parameter format of a decrypting unit and a playback unit of a first operating system into the parameters that are executable for the second operating system. In this way, the second operating system can share the resources of the decrypting unit and the playback unit of the first operating system. Besides, the second operating system can also obtain the register information from the first operating system via the interface unit.

Subsequently, the decrypting unit is used to access at least one kind of encrypted multimedia data stored in a storage unit and the register information corresponding to the encrypted multimedia data from the first operating system to perform a decrypting operation. After the decrypting operation is completed, the playback unit is used to access the multimedia data that has been decrypted by the decrypting unit to perform a playback operation.

In addition, the present invention further has a multimedia-receiving unit that is used to receive at least one kind of remote multimedia data and store the data into the storage unit.

Since the second operating system of the present invention can share the system resources of the first operating system, the present invention can directly activate the second operating system instead of the first operating system to play the encrypted multimedia data. Hence, the present invention effectively reduces the time consumed to active the first operating system that consumes more system resources and occupies larger memory space. Besides, the present invention saves memory space and electric power effectively.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A computer system for playing encrypted multimedia data, comprising:
a first operating system (OS) that consumes system resources heavily;
a register information stored in the first operating system to provide a decrypting information for at least one kind of the encrypted multimedia data; and
a second operating system that consumes the system resources slightly;
wherein the register information stored in the first operating system is available to the second operating system.

2. The computer system as claimed in claim 1, wherein the decrypting information is a decrypting key corresponding to the at least one kind of the encrypted multimedia data.

3. The computer system as claimed in claim 1, wherein the register information is a register code corresponding to an application program to make the application program executable.

4. The computer system as claimed in claim 1, wherein the register information is a cookie information having a recognition information that is transmitted from a remote website server to the computer system.

5. A computer system for playing encrypted multimedia data, the computer system having a first operating system that heavily consumes system resources and a second operating system that slightly consumes the system resources, the computer system running the second operating system for encrypting the encrypted multimedia data, the computer system comprising:
a register code stored in the first operating system to provide a decrypting information for at least one kind of the encrypted multimedia data;
a decrypting unit that cooperates with the second operating system to access the decrypting information and the at least one kind of the encrypted multimedia data to perform a decrypting operation; and
a playback unit that cooperates with the second operating system to access the at least one kind of the encrypted multimedia data decrypted by the decrypting unit to perform a playback operation.

6. The computer system as claimed in claim 5, wherein the decrypting information is a decrypting key corresponding to the at least one kind of the encrypted multimedia data, and the decrypting unit uses the decrypting key to decrypt the at least one kind of the encrypted multimedia data.

7. The computer system as claimed in claim 5, wherein the decrypting information is the register code corresponding to an application program to make the application program executable.

8. The computer system as claimed in claim 5, wherein the decrypting information is a cookie information having a recognition information that is transmitted from a remote website server to the computer system.

9. The computer system as claimed in claim 5, further comprising a storage unit to provide at least one kind of local multimedia data, wherein the at least one kind of local multimedia data is transmitted directly to the playback unit if the at least one kind of local multimedia data has not been encrypted.

10. The computer system as claimed in claim 9, further comprising a multimedia receiving unit that is used to receive at least one kind of remote multimedia data and store the at least one kind of remote multimedia data to the storage unit.

11. The computer system as claimed in claim 10, wherein the multimedia receiving unit is capable of converting the remote multimedia data that is analog to digital multimedia data.

12. The computer system as claimed in claim 5, further comprising an input unit to provide an external command.

13. The computer system as claimed in claim 12, wherein the input unit is a wireless remote controller.

14. The computer system as claimed in claim 12, further comprising a central processing unit (CPU) to receive the external command from the input unit to drive a multimedia receiving unit to receive at least one kind of remote multimedia data.

15. The computer system as claimed in claim 5, wherein the second operating system shares application programs installed in the first operating system via an interface unit.

16. A method for playing encrypted multimedia data, the method being used for a computer system having a first operating system that heavily consumes system resources and a second operating system that slightly consumes the system resources, the computer system running the second operating system for encrypting the encrypted multimedia data, the method comprising:
storing a register information in the first operating system to an encrypting information corresponding to at least one kind of the encrypted multimedia data;
using an encrypting unit that cooperates with the second operating system to access the register information and the at least one kind of the encrypted multimedia data to perform a decrypting operation; and
using a playback unit that cooperates with the second operating system to access the at least one kind of the encrypted multimedia data that has been decrypted to perform a playback operation.

17. The method as claimed in claim 16, further comprising:
storing at least one kind of multimedia data to a storage unit; wherein the at least one kind of multimedia data is transmitted directly to the playback unit if the at least one kind of multimedia data has not been encrypted and then the playback unit performs a playback operation.

18. The method as claimed in claim 17, further comprising:
using an input unit to provide an external command to drive a multimedia receiving unit to receive at least one kind of remote multimedia data and store the at least one kind of remote multimedia data to the storage unit.
